(19) United States
(12) Patent Application Publication
(10) Pub. No.: US 2017/0232708 A1
(43) Pub. Date: Aug. 17, 2017

(54) COMPOSITE MATERIAL

(71) Applicants: ThyssenKrupp Steel Europe AG, Duisburg (DE); ThyssenKrupp AG, Essen (DE)

(72) Inventor: Peter KLAUKE, Schwerte (DE)

(73) Assignees: ThyssenKrupp Steel Europe AG, Duisburg (DE); ThyssenKrupp AG, Essen (DE)

(21) Appl. No.: 15/518,602

(22) PCT Filed: Aug. 27, 2015
(86) PCT No.: PCT/EP2015/069609

§ 371 Date: Apr. 12, 2017

(30) Foreign Application Priority Data
Oct. 14, 2014 (DE) 10 2014 014 976.5

(51) Int. Cl. B32B 15/08; B32B 27/20; B32B 15/18

(52) U.S. Cl. CPC B32B 15/08; B32B 15/18; B32B 27/20

(57) ABSTRACT

A composite material may include at least two metallic layers and at least one polymer layer disposed between the metallic layers. The polymer layer may comprise at least one welding additive. One example object of the present disclosure, which is to propose a composite material that overcomes the disadvantages in the prior art, may be achieved for a composite material that includes, in addition to the at least one polymer layer and the at least two metallic layers, sponge iron in an amount of 0.1% to 30.0% by weight as the welding additive. In some examples, the sponge iron may include a metallic and/or nonmetallic inorganic coating.”

The invention relates to a composite material comprising at least two metallic layers and at least one polymer layer disposed between the metallic layers, the polymer layer comprising at least one welding additive.

Generic composite materials are known from the prior art. The composite material which dampens structural noise and is sold by the applicant under the tradename Bondal® consists of two outer steel sheets with a polymer layer disposed between them, it being possible for the polymer layer to consist for example of an acrylate, silicone, polyamide and/or polyethylene, polyester material or an epoxy resin. Joining the structural noise-damping composite material to other components by means of welding, for example, more particularly resistance welding, is generally not a problem. To improve the electrical conductivity and to make a composite material suitable for resistance welding, welding additives are added to the polymer layer, as disclosed in the U.S. publication text 2009/0142538. The disadvantages of the welding additives are manifold. Welding additives having a high specific weight in comparison to the plastic exhibit very unfavorable settling behavior in the liquid or liquid-melt polymer, rendering it not always possible to adequately ensure a uniform and homogeneous distribution of the pigments in the polymer either during processing or in the finished product. With certain welding additives, moreover, it is not always possible to rule out an adverse chemical reaction with the polymer, which may negatively impact not only the consistency of the liquid or liquid-melt polymer but also the peeling and shearing effect of the plastic and/or its adhesion in the bonded assembly. Furthermore, certain welding additives may also negatively influence the loss factor curve over a broad temperature range from 50 to 500 Hz. Certain pigments investigated (Al flakes, FeAl 50/50, FeSi45, Zn powders, FeSiAl, Fe3P powders) and pigment mixtures composed of the aforementioned products have been found, on account of their specific resistances, to have narrow welding ranges in the order of magnitude of in particular Δ I <500 amperes or to be completely impossible to weld.

On this basis, it is an object of the present invention to propose a composite material which overcomes the aforesaid disadvantages in the prior art.

For a generic composite material, the object addressed is achieved through the polymeric layer comprising sponge iron in an amount of 0.1 to 30.0 wt %.

Investigations have shown that, surprisingly, sponge iron, which is known, for example, under the product name “MH300” from Höganäs, as a welding additive meets all of the requirements imposed. Sponge iron may be added in powder, pigment and/or granular form to the polymer, with the average diameter of the welding additive being substantially smaller than 0.2 mm, more particularly smaller than 0.1 mm, preferably smaller than 0.05 mm, and its low specific weight of around 2.85 g/cm³ allows simplified and advantageous processing; in particular, unwanted settling behavior or separation, particularly following addition of the welding additive to the containers which store a liquid polymer, more particularly a liquid and solvent-containing polymer, can be substantially prevented. In order to ensure electrical conductivity through the polymeric layer and a positive welding outcome, the polymer layer comprises at least 0.1 wt %, more particularly at least 0.5 wt %, preferably at least 1.0 wt % of sponge iron. In order not to have an adverse effect on the mechanical properties, particularly the adhesion between the metallic layers and the loss factor of the polymer, the amount of sponge iron is restricted to not more than 30.0 wt %, more particularly to not more than 20.0 wt %, preferably to not more than 15.0 wt %. The use of sponge iron as a welding additive allows relatively large welding ranges to be set, more particularly of Δ I >600 amperes, more particularly Δ I >800 amperes, preferably Δ I >1000 amperes. Furthermore, both the breadth of the welding range and also the position of the welding range over the specific resistance can be optimized further through different kinds of a subsequent metallic and/or nonmetallic inorganic coating on the sponge iron, such as, for example, a chemical phosphating, chromating or nickelization, a metal electroplating, or else by means of CVD or PVD techniques. Depending on the requirement, sponge iron may be used in uncoated or coated form or in combination. In the case of resistance welding, moreover, there are no welding vapors produced that are injurious to health, and the composite material of the invention, in comparison to a composite material without welding additives, has no adverse effect on the adhesion of the bonded assembly, such as the peel and shear values, for example. Composite materials of the invention, especially those with structural noise-damping properties, can be provided for constructions in all sectors where bonds are produced by resistance welding or spot resistance welding, such as, in particular, for a resistance-welded construction which comprises at least one composite material of the invention and at least one other component.

In another embodiment of the invention, the metallic layers are formed of a steel material. Uncoated or metallically coated, more particularly galvanized, steel materials, examples being galvanized deep-drawing steels, are relatively favorably priced and are therefore outstandingly suitable for constructions preferably in vehicle construction that require cathodic corrosion protection. Light metal materials as well, such as aluminum and magnesium materials, may be used as metallic layers, if there are also weight savings to be made in the composite material. Different combinations of the aforementioned metal materials are possible too. The metallic layers have a thickness of 0.1 to 3.0 mm, more particularly of 0.15 to 2.0 mm, preferably of 0.2 to 1.5 mm, and more preferably of 0.3 to 1.2 mm.

In combination with the polymer layer, which has a thickness of 0.01 to 0.2 mm, more particularly 0.02 to 0.1 mm, and preferably 0.025 to 0.05 mm, it is possible to provide a structural noise-damping composite material. The polymer layer can be introduced in the form of a film, more particularly an extruded film, preferably an extruded adhesive film with homogeneously dispersed sponge iron, between the metallic layers, and then laminated to the metallic layers. Another possibility, moreover, is that of direct extrusion of the liquid-melt polymer, enriched with sponge iron, onto a metallic layer. Alternatively, the polymer/polymer layer with homogeneously dispersed sponge iron can be applied in liquid form, preferably by the coil coating process (strip coating), at least to one metallic layer, and then crosslinked in a tunnel oven at appropriately high temperatures.

For the purpose of improving the acoustic properties and also, for example, the shearing value, the polymer layer may comprise additional fillers. Fillers used may be, in particular, organic fibers, examples being natural fibers (cotton fibers, for example), regenerated fibers (cellulose fibers, for example) and/or synthetic, manmade fibers (glass fibers, for example). The fiber length is preferably 0.01 to 0.2 mm, with a slenderness ratio (ratio of fiber length to fiber diameter) of less than 5 being particularly preferred. The polymer layer may comprise at least 0.1 wt % of filler, more particularly at least 0.5 wt % of filler, preferably at least 1.0 wt % of filler, and more preferably 1.5 wt % of filler, the filler being restricted to not more than 25.0 wt %, more particularly to not more than 20.0 wt %, preferably to not more than 15.0 wt %, and more preferably to not more than 10.0 wt %, in order not to impair the advantageous properties.

In the simplest embodiment, the composite material of the invention consists of two metallic layers (outer layers) and a polymer layer comprising sponge iron disposed between the outer layers. The number of the respective layers may certainly be increased as and when required, and so it is also possible, for example, to provide a five-layer composite material, consisting of three metallic layers and a polymer layer disposed between each of the metallic layers and comprising sponge iron in each case.

1.-8. (canceled)

9. A composite material comprising a polymer layer disposed between two metallic layers, wherein the polymer layer comprises sponge iron in an amount of 0.1% to 30.0% by weight as a welding additive.

10. The composite material of claim 9 wherein the amount of the sponge iron in the polymer layer is not less than 1.0% and not more than 15.0% by weight.

11. The composite material of claim 9 wherein the sponge iron includes a metallic inorganic coating.

12. The composite material of claim 9 wherein the sponge iron includes a nonmetallic inorganic coating.

13. The composite material of claim 9 wherein the sponge iron includes a metallic and/or nonmetallic inorganic coating.

14. The composite material of claim 9 wherein the two metallic layers comprise steel, aluminum, magnesium, or a combination thereof.

15. The composite material of claim 9 wherein the two metallic layers have a thickness of 0.1 to 3.0 mm.

16. The composite material of claim 9 wherein the two metallic layers have a thickness of 0.15 to 2.0 mm.

17. The composite material of claim 9 wherein the two metallic layers have a thickness of 0.2 to 1.5 mm.

18. The composite material of claim 9 wherein the two metallic layers have a thickness of 0.3 to 1.2 mm.

19. The composite material of claim 9 wherein the polymer layer has a thickness of 0.01 to 0.2 mm.

20. The composite material of claim 9 wherein the polymer layer has a thickness of 0.02 to 0.1 mm.

21. The composite material of claim 9 wherein the polymer layer has a thickness of 0.025 to 0.05 mm.

22. The composite material of claim 9 wherein the polymer layer comprises fillers in an amount of 0.1% to 25.0% by weight.

23. The composite material of claim 9 wherein the polymer layer comprises fillers in an amount of 0.5% to 20.0% by weight.

24. The composite material of claim 9 wherein the polymer layer comprises fillers in an amount of 1.0% to 15.0% by weight.

25. The composite material of claim 9 wherein the polymer layer comprises fillers in an amount of 1.5% to 10.0% by weight.

26. A resistance-welded construction comprising a composite material, the composite material comprising a polymer layer disposed between two metallic layers, wherein the polymer layer includes sponge iron in an amount of 0.1% to 30.0% by weight as a welding additive.

27. The resistance-welded construction of claim 26 configured as a vehicle construction.
